(19) United States
(12) Patent Application Publication
(10) Pub. No.: US 2025/0221880 A1
(43) Pub. Date: Jul. 10, 2025

(54) TELESCOPIC FOLDING WALKING AID

(71) Applicant: Xinzhiyuan Medical Equipment (Guangdong) Co., Ltd., Foshan (CN)

(72) Inventors: Zhongliang Liu, Foshan (CN); Xinsheng Xu, Foshan (CN); Tianxi Wang, Foshan (CN)

(21) Appl. No.: 18/761,251

(22) Filed: Jul. 1, 2024

(30) Foreign Application Priority Data
Jan. 9, 2024 (CN) 2024200425049

(51) Int. Cl. A61H 3/02

(52) U.S. Cl. CPC A61H 3/0244; A61H 2201/0161; A61H 2201/0192; A61H 2201/1635

(57) ABSTRACT

The invention discloses a telescopic folding walking aid, which comprises a left support, a right support and a connecting frame; the left support and right support are symmetrically arranged, and connecting frame is provided with a folding mechanism; one end of connecting frame is connected with left support through first connecting mechanism, and other end thereof is connected with right support through second connecting mechanism; folding mechanism comprises a first connecting sleeve, a second connecting sleeve, a spring, a limiting member, a screw, a nut and a button, a first ear plate and a second ear plate are arranged at joint of second connecting sleeve and first connecting sleeve; folding mechanism is arranged on connecting frame, so the invention is convenient to fold and store, and occupies a small space when not used, height of which can be adjusted according to height of user.

### 1. TECHNICAL FIELD

The invention relates to the technical field of walking aid, in particular to a telescopic folding walking aid.

### 2. BACKGROUND ART

The walking aid is supported by the appliance, so that old people with inconvenient legs and feet, patients and other people with inflexible legs and feet and even without walking ability can take care of themselves and can walk out like normal people.

The existing walking aids do not have functions of adjusting height and folding at the same time, which cannot be suitable for people with different heights, and cannot be stored in a folded manner.

Therefore, a telescopic folding walking aid has become an urgent problem to be solved by people.

### 3. SUMMARY OF THE INVENTION

The technical problems to be solved by the invention is that the existing walking aids do not have functions of adjusting height and folding at the same time, which cannot be suitable for people with different heights, and cannot be stored in a folded manner.

In order to solve the technical problem, the technical scheme provided by the invention is a telescopic folding walking aid, which comprises a left support, a right support and a connecting frame, wherein the left support and the right support are symmetrically arranged, and the connecting frame is provided with a folding mechanism; one end of the connecting frame is connected with the left support through a first connecting mechanism, and other end thereof is connected with the right support through a second connecting mechanism;

the folding mechanism comprises a first connecting sleeve, a second connecting sleeve, a spring, a limiting member, a screw, a nut and a button, wherein a first ear plate and a second ear plate are arranged at joint of the second connecting sleeve and the first connecting sleeve; joint of the first connecting sleeve and the second connecting sleeve is provided with a connecting post and a groove, and is provided on outer surface of the spring, the spring is sleeved on the connecting post, and the limiting member is set in the groove; the screw passes through the first ear plate, connecting post and second ear plate at the same time and is fixed by means of the nut; the button is set on outer side of the screw, inner surface of the first ear plate is equipped with the first clamping slot adapted to the limiting member, and outer surface of the second ear plate is provided with the second clamping slot adapted to the nut;

the first connecting mechanism and second connecting mechanism have same structure and size, the first connecting mechanism includes an operating handle and a rotary connecting member, wherein one end of the rotary connecting member is set on the left support and and other end thereof is connected to the connecting frame; the operating handle is used for adjusting rotary angle of the rotary connecting member.

Further, the left support comprises a U-shaped support, an H-shaped support and support legs, wherein the U-shaped support is set on top of the H-shaped support, support legs are set on bottom of the H-shaped support and is detachably connected to the H-shaped support, and height of the support legs and H-shaped support are adjustable.

Further, the support legs include a first support leg and a second support leg of same structure and size, wherein the first support leg is provided with a plurality of linearly disposed adjusting holes, and bottom of the H-shaped support is provided with a compression spring that is adapted to the adjusting holes.

Further, the U-shaped support is provided with a first reinforcing member and a second reinforcing member, the rotary connecting member is sleeved to the first reinforcing member, and the rotary connecting member is located below the first reinforcing member; the second reinforcing member is set below the first reinforcing member, and the second reinforcing member is set in a U-shape.

Further, bottom of the first support legs are provided with first non-slip pads, and bottom of the second support legs are provided with second non-slip pads.

Further, bottom of the first support legs are provided with wheels, and bottom of the second support legs are provided with third non-slip pads.

Further, bottom of the first support legs are provided with fourth non-slip pads, and bottom of the second support legs are provided with walker ski glides.

Further, the connecting frame comprises a first connecting frame and a second connecting frame, the first connecting sleeve is sleeved to left end of the first connecting frame, right end of the first connecting frame is connected to the right support, the second connecting sleeve is sleeved to right end of the second connecting frame, and left end of the second connecting frame is connected to the left support.

Compared with the prior art, the advantageous effects of the invention are as follows: the folding mechanism is arranged on the connecting frame, so that the invention is convenient to fold and store, and occupies a small space when not used; since height of the support legs and the H-shaped support can be adjusted by means of cooperation of the compression spring and adjusting holes, the height of the invention can be reasonably adjusted according to height of the user; bottom of support legs are provided with three types of auxiliary structures, namely non-slip mats, universal wheels, and walker ski glides, respectively, and different accessory has different effect, so that the invention can choose different accessories according to the need; the invention is reasonable in design and worthy of great promotion.

### 4. BRIEF DESCRIPTION OF ACCOMPANY DRAWINGS

FIG. 1 is first structural diagram of the telescopic folding walking aid provided by the invention.

FIG. 2 is first exploded view of the folding mechanism in the telescopic folding walking aid provided by the invention.

FIG. 3 is second exploded view of the folding mechanism in the telescopic folding walking aid provided by the invention.

FIG. 4 is left view of the telescopic folding walking aid provided by the invention.

FIG. 5 is second structural diagram of the telescopic folding walking aid provided by the invention.

FIG. 6 is third structural diagram of the telescopic folding walking aid provided by the invention.

FIG. 7 is top view of the folding mechanism in the telescopic folding walking aid provided by the invention.

FIG. 8 is sectional view along direction of A-A;

FIG. 9 is schematic diagram illustrating a change of the first connecting mechanism of the folding mechanism in the telescopic folding walking aid provided by the invention;

FIG. 10 is half-folded diagram of the invention;

FIG. 11 is fully-folded diagram of the invention.

As shown in the accompanying drawings: 1 left support, 2 right support, 3 connecting frame, 4 folding mechanism, 5 first connecting mechanism, 6 second connecting mechanism, 7 first connecting sleeve, 8 second connecting sleeve, 9 spring, 10 limiting member, 11 screw, 12 nut, 13 button, 14 first ear plate, 15 second ear plate, 16 connecting post, 17 groove, 18 operating handle, 19 rotary connecting member, 20 U-shaped support, 21 H-shaped support, 22 support leg, 23 first support leg, 24 second support leg, 25 adjusting hole, 26 compression spring, 27 first reinforcing member, 28 second reinforcing member, 29 first non-slip pad, 30 second non-slip pad, 31 universal wheel, 32 third non-slip pad, 33 fourth non-slip pad, 34 walker ski glide, 35 first connecting frame, 36 second connecting frame, 37 first clamping slot, 38 second clamping slot.

### 5.SPECIFIC EMBODIMENT OF THE INVENTION

The invention is further described in detail hereinafter with reference to the drawings.

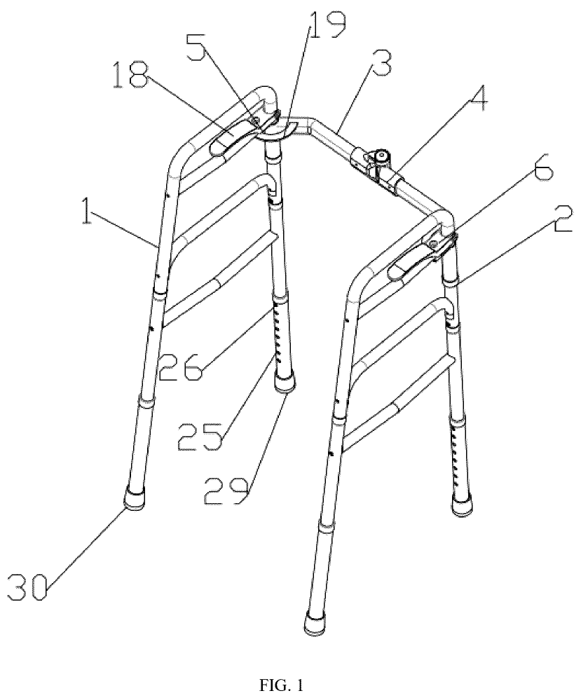

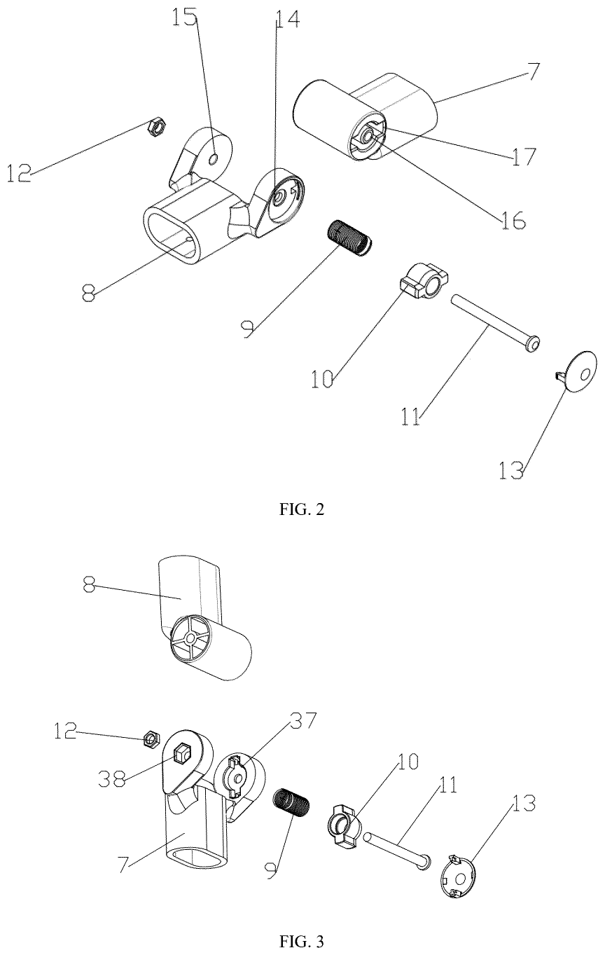

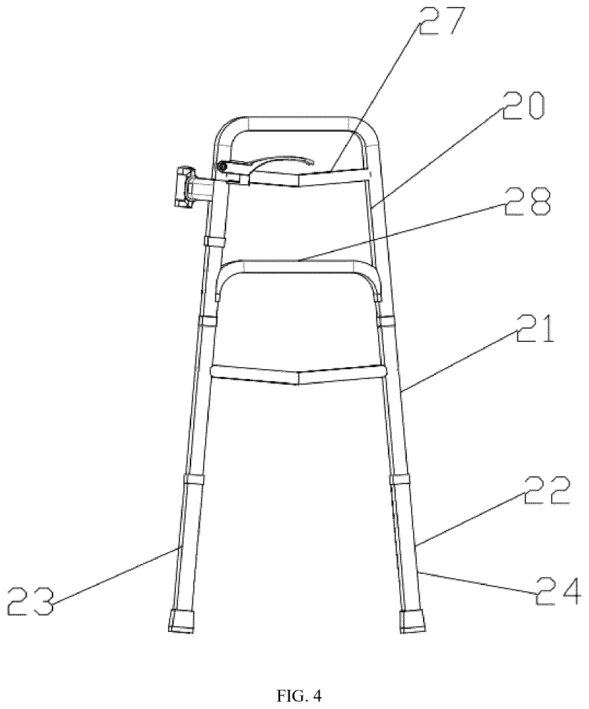

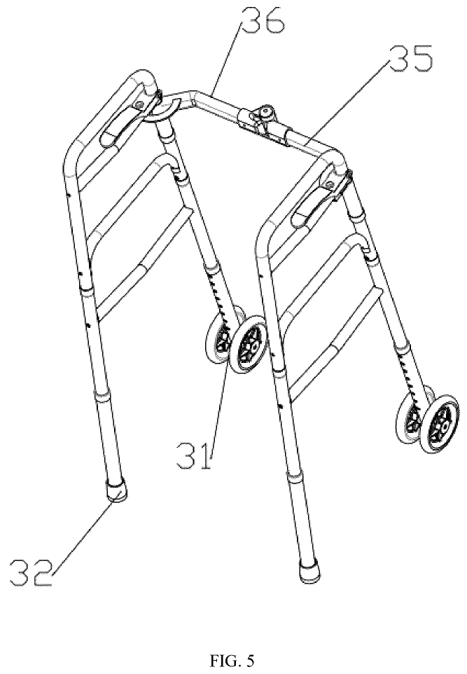

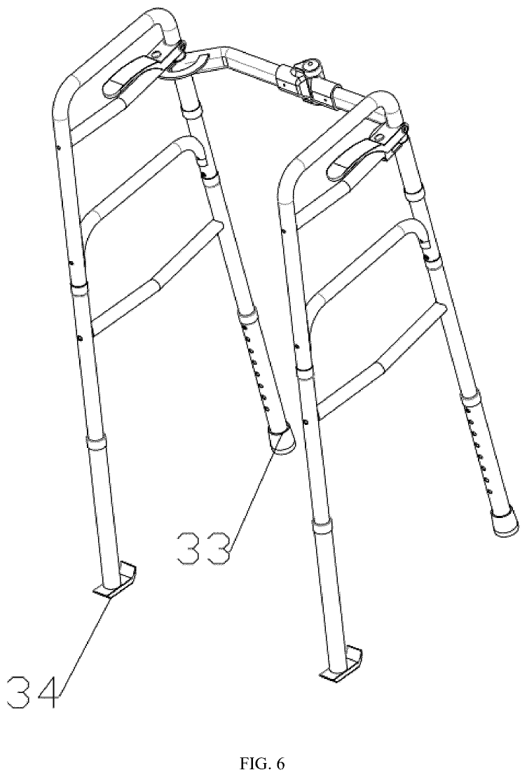

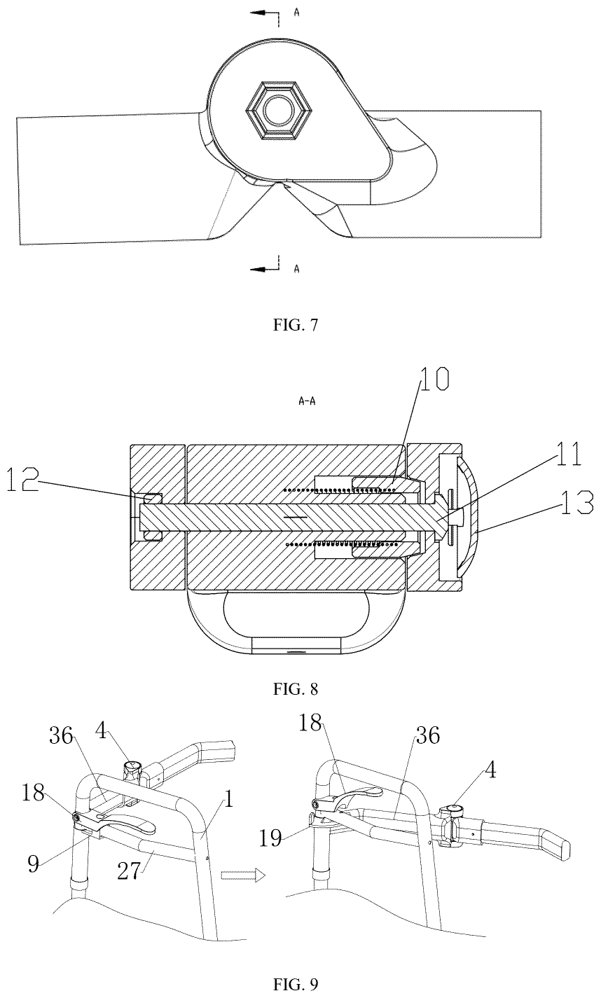

With reference to FIG. 1 to FIG. 8, the invention is further described in detail below.

A telescopic folding walking aid, which comprises a left support 1, a right support 2 and a connecting frame 3, wherein the left support 1 and the right support 2 are symmetrically arranged, and the connecting frame 3 is provided with a folding mechanism 4; one end of the connecting frame 3 is connected with the left support 1 through a first connecting mechanism 5, and other end thereof is connected with the right support 2 through a second connecting mechanism 6;

the folding mechanism 4 comprises a first connecting sleeve 7, a second connecting sleeve 8, a spring 9, a limiting member 10, a screw 11, a nut 12 and a button 13, wherein a first ear plate 14 and a second ear plate 15 are arranged at joint of the second connecting sleeve 8 and the first connecting sleeve 7; joint of the first connecting sleeve 7 and the second connecting sleeve 8 is provided with a connecting post 16 and a groove 17, the spring 9 is sleeved on the connecting post 16, and the limiting member 10 is set in the groove 17, and is provided on outer surface of the spring 9; the screw 11 passes through the first ear plate 14, connecting post 16 and second ear plate 15 at the same time and is fixed by means of the nut 12; the button 13 is set on outer side of the screw 11, inner surface of the first ear plate 14 is equipped with the first clamping slot 37 adapted to the limiting member 10, and outer surface of the second ear plate 15 is provided with the second clamping slot 38 adapted to the nut 12;

the first connecting mechanism 5 and second connecting mechanism 6 have same structure and size, the first connecting mechanism 5 includes an operating handle 18 and a rotary connecting member 19, wherein one end of the rotary connecting member 19 is set on the left support 1 and and other end thereof is connected to the connecting frame 3; the operating handle 18 is used for adjusting rotary angle of the rotary connecting members 19.

The left support 1 comprises a U-shaped support 20, an H-shaped support 21 and support legs 22, wherein the U-shaped support 20 is set on top of the H-shaped support 21, support legs 22 are set on bottom of the H-shaped support 21 and is detachably connected to the H-shaped support 21, and height of the support legs 22 and H-shaped support 21 are adjustable.

The support legs 22 include a first support leg 23 and a second support leg 24 of same structure and size, wherein the first support leg 23 is provided with a plurality of linearly disposed adjusting holes 25, and bottom of the H-shaped support 21 is provided with a compression spring 26 that is adapted to the adjusting holes 25.

The U-shaped support 20 is provided with a first reinforcing member 27 and a second reinforcing member 28, the rotary connecting member 19 is provided below the first reinforcing member 27, the operating handle 18 is provided above the rotary connecting member 19, the second reinforcing member 28 is set below the first reinforcing member 27, and the second reinforcing member 28 is set in a U-shape.

Bottom of the first support legs 23 are provided with first non-slip pads 29, and bottom of the second support legs 24 are provided with second non-slip pads 30.

Bottom of the first support legs 23 are provided with wheels 31, and bottom of the second support legs 24 are provided with third non-slip pads 32.

Bottom of the first support legs 23 are provided with fourth non-slip pads 33, and bottom of the second support legs 24 are provided with walker ski glides 34.

The connecting frame 3 comprises a first connecting frame 35 and a second connecting frame 36, the first connecting sleeve 7 is sleeved to left end of the first connecting frame 35, right end of the first connecting frame 35 is hingedly connected to the right support 2, the second connecting sleeve 8 is sleeved to right end of the second connecting frame 36, and left end of the second connecting frame 36 is hingedly connected to the left support 1.

Two rotary connecting members 19 are respectively fixedly connected to the first connecting frame 35 and the second connecting frame 36, wherein the first connecting frame 35 is hingedly connected to the right support 2, the second connecting frame 36 is hingedly connected to the left support 1, and two operating handles 18 are hingedly connected to the left support 1 and the right support 2, and the operating handles 18 form a limiting effect on the rotary connecting members 19; as shown in FIG. 9, the rotary connecting members 19 of the first connecting mechanism 5 is in the shape of a circular arc, the rotary connecting members 19 are fixedly connected to the second connecting frame 36, the second connecting frame 36 is hinged to the left support 1, and the rotary connecting members 19 rotate following the second connecting frame 36; when the second connecting frame 36 rotates and needs to be opened, the operating handles 18 are raised upward, and when the second connecting frame 36 rotates and opens in place, the operating handles 18 are rotated downward in place to form a limit on end of the rotary connecting members 19, and at this time, the second connecting frame 36 and the left support 1 can not be folded, when there is a need to fold, lifting the operating handles 18, remove the locking restriction of operating handles 18 on the rotary connecting members 19, then the second connecting frame 36 and the left support 1 can be folded, folding and opening of the first connecting frame 35 and the right support 2 can be completed in the same way.

The specific implementation process of the invention, telescopic folding walking aid, is as follows: firstly, adjust the height of the support legs 22 relative to the H-shaped support 21 according to height of the user, and then unfold the left support 1 and the right support 2; in the process of unfolding, press the button 13, and the limiting member 10 is pushed from the first clamping slot 37 by the button 13 into the groove 17 completely, then unlocking at this time, so that the first connecting sleeve 7 and the second connecting sleeve 8 can be rotated relative to each other; when the first connecting sleeve 7 and the second connecting sleeve 8 form 180 degrees, the spring 9 gives a rebound force to the limiting member 10, so that the limiting member 10 is partially rebounded into the first clamping slot 37 and partially snapped into the groove 17, so that the folding mechanism 4 is in the locking state, and the first connecting frame 35 and the second connecting frame 36 are in the locking state of being opened;

afterwards, the left support 1 and the second connecting frame 36 are opened, after opening, the operating handle 18 of the first connecting mechanism 5 is rotated downward to form a limit lock on end of the rotary connecting member 19 of the first connecting mechanism 5; at this time, the left support 1 and the second connecting frame 36 are in open locking state, and cannot be folded;

opening the right support 2 and the first connecting frame 35, after opening, the operating handle 18 of the second connecting mechanism 6 is rotated downward to form a limit lock on end of the rotary connecting member 19 of the second connecting mechanism 6; at this time, the right support 2 and the second connecting frame 36 are in open locking state, and cannot be folded;

The above completes the opening of the entire walking aid for normal use.

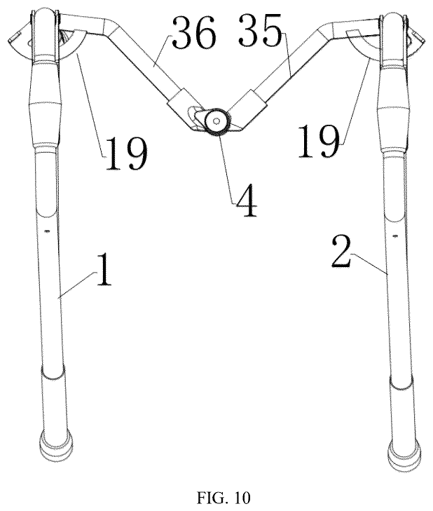

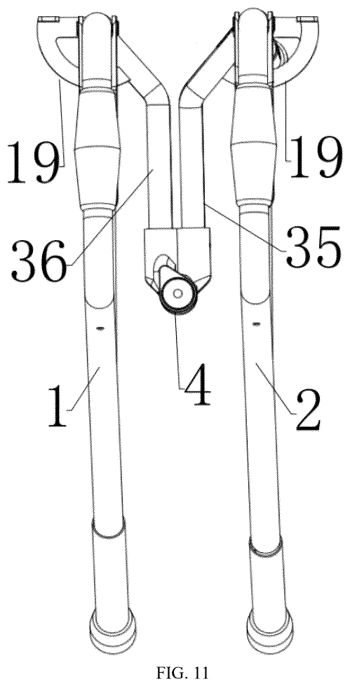

After use, press the button 13, the limiting member 10 is pushed into the groove 17 completely from the first clamping slot 37 by the button 13, the limiting member 10 at the same time gives a pressure to the spring 9, and then rotate the first connecting sleeve 7 and second connecting sleeve 8, then the first connecting frame 35 and second connecting frame 36 are folded together; opening the operating handle 18 of the first connecting mechanism 5 and the operating handle 18 of the second connecting mechanism 6, which means the operating handles 18 no longer form limiting effect on ends of the rotary connecting members 19, and complete folding of the left support 1 and the second connecting frame 36, and folding of the right support 2 and the first connecting frame 35, as shown in FIG. 10, which is a half-folded state in the folding process, and as shown in FIG. 11, which is a fully folded state in the folding process.

The invention adopts a folding mechanism 4 on the connecting frame, a first connecting mechanism 5 between the left support 1 and the second connecting frame 36 of the connecting frame 3, and a second connecting mechanism 6 between the right support 2 and the first connecting frame 35 of the connecting frame 3, so that the invention is easy to fold and collect, and occupies a small space when not used; since height of the support legs 22 and the H-shaped support 21 can be adjusted by means of cooperation of the compression spring 26 and adjusting holes 25, the height of the invention can be reasonably adjusted according to height of the user; bottom of support legs 22 are provided with three types of auxiliary structures, namely non-slip mats, universal wheels 31, and walker ski glides 34, respectively, and different accessory has different effect, so that the invention can choose different accessories according to the need; the invention is reasonable in design and worthy of great promotion.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A telescopic folding walking aid, which comprises a left support, a right support and a connecting frame, wherein the left support and the right support are symmetrically arranged, and the connecting frame is provided with a folding mechanism; one end of the connecting frame is connected with the left support through a first connecting mechanism, and other end thereof is connected with the right support through a second connecting mechanism;
the folding mechanism comprises a first connecting sleeve, a second connecting sleeve, a spring, a limiting member, a screw, a nut and a button, wherein a first ear plate and a second ear plate are arranged at joint of the second connecting sleeve and the first connecting sleeve; joint of the first connecting sleeve and the second connecting sleeve is provided with a connecting post and a groove, the spring is sleeved on the connecting post, and the limiting member is set in the groove and is provided on outer surface of the spring; the screw passes through the first ear plate, connecting post and second ear plate at the same time and is fixed by means of the nut; the button is set on outer side of the screw, inner surface of the first ear plate is equipped with the first clamping slot adapted to the limiting member, and outer surface of the second ear plate is provided with the second clamping slot adapted to the nut;
the first connecting mechanism and second connecting mechanism have same structure and size, the first connecting mechanism includes an operating handle and a rotary connecting member, wherein one end of the rotary connecting member is set on the left support and other end thereof is connected to the connecting frame; the operating handle is used for adjusting rotary angle of the rotary connecting member.

2. The telescopic folding walking aid of claim 1, wherein the left support comprises a U-shaped support, an H-shaped support and support legs, wherein the U-shaped support is set on top of the H-shaped support, support legs are set on bottom of the H-shaped support and is detachably connected to the H-shaped support, and height of the support legs and H-shaped support are adjustable.

3. The telescopic folding walking aid of claim 2, wherein the support legs include a first support leg and a second support leg of same structure and size, wherein the first support leg is provided with a plurality of linearly disposed adjusting holes, and bottom of the H-shaped support is provided with a compression spring that is adapted to the adjusting holes.

4. The telescopic folding walking aid of claim 2, wherein the U-shaped support is provided with a first reinforcing member and a second reinforcing member, the rotary connecting member is located below the first reinforcing member, and the operating handle is provided above the rotary connecting member; the second reinforcing member is set below the first reinforcing member, and the second reinforcing member is set in a U-shape.

5. The telescopic folding walking aid of claim 3, wherein bottom of the first support legs are provided with first non-slip pads, and bottom of the second support legs are provided with second non-slip pads.

6. The telescopic folding walking aid of claim 3, wherein bottom of the first support legs are provided with wheels, and bottom of the second support legs are provided with third non-slip pads.

7. The telescopic folding walking aid of claim 3, wherein bottom of the first support legs are provided with fourth non-slip pads, and bottom of the second support legs are provided with walker ski glides.

8. The telescopic folding walking aid of claim 1, wherein the connecting frame comprises a first connecting frame and a second connecting frame, the first connecting sleeve is sleeved to left end of the first connecting frame, right end of the first connecting frame is connected to the right support, the second connecting sleeve is sleeved to right end of the second connecting frame, and left end of the second connecting frame is connected to the left support.
